(19) United States
(12) Patent Application Publication
(10) Pub. No.: US 2011/0181975 A1
(43) Pub. Date: Jul. 28, 2011

(54) METHOD OF MANUFACTURING A MASTER DISK FOR MAGNETIC TRANSFER

(75) Inventor: Hiroto Kikuchi, Nagano (JP)

(73) Assignee: Fuji Electric Device Technology Co., Ltd., Tokyo (JP)

(21) Appl. No.: 12/845,478

(22) Filed: Jul. 28, 2010

(30) Foreign Application Priority Data
Jan. 22, 2010 (JP) 2010-012035

(51) Int. Cl. G11B 5/86; G11B 5/127

(52) U.S. Cl. 360/16; 216/22; G9B/5.04; G9B/5.308

(57) ABSTRACT

A method of manufacturing a master disk for magnetic transfer is provided in which a pattern configuration does not change and burrs that require a polishing process are not generated. The method of manufacturing a master disk for magnetic transfer can include preparing a nonmagnetic body, forming a pattern of recessed parts on the nonmagnetic body, and forming a ferromagnetic material layer by depositing a ferromagnetic material on a surface of the nonmagnetic body having the pattern of recessed parts thereon. The method can further include forming a pattern of ferromagnetic material layers at the recessed parts by removing an excess portion of the ferromagnetic layer without using a mask. An etching rate of the nonmagnetic body can be larger than an etching rate of the ferromagnetic material layer in the operation of forming a pattern of ferromagnetic material layers at the recessed parts.

### CROSS-REFERENCE TO RELATED APPLICATION

This application claims priority under 35 U.S.C. §119 from Japanese Patent Application 2010-012035, filed Jan. 22, 2010, the entirety of which is incorporated herein by reference.

### BACKGROUND OF THE INVENTION

1. Field of the Invention

The present invention relates to a method of manufacturing a master disk for magnetic transfer. The present invention provides, in particular, a method of manufacturing a master disk for magnetic transfer that does not cause deformation of a pattern configuration and does not generate a burr which would require a polishing process.

2. Description of the Related Art

Common HDDs conduct recording and reproduction of data using a magnetic head running and floating over a magnetic recording medium at a height of about 10 nm. The bit information on the magnetic recording medium is stored in concentrically arranged data tracks. The magnetic head is positioned on the data tracks in the data recording and reproduction processes. Servo data for positioning are stored on the magnetic recording medium. The servo data are recorded concentrically to the data tracks with a constant angular spacing. The servo data have generally been recorded using a magnetic head. However, with increase in the recording tracks in recent years, a problem has emerged that increased time duration for writing the servo data using a magnetic head lowers efficiency in HDD production.

In view of the above described problem, a magnetic transfer method has been proposed for recording servo data altogether in one process onto a magnetic recording medium (a medium to which data is to be transferred) from a master disk carrying the servo data in place of servo data recording by means of a magnetic head. Japanese Unexamined Patent Application Publication No. 2002-083421, for example, discloses a method for servo data transfer on a master disk to a perpendicular magnetic recording medium, the method using a master disk including a ferromagnetic material arranged in a pattern (a servo pattern) corresponding to the servo data.

One of magnetic transfer methods applied to perpendicular magnetic recording media is an edge transfer method as shown in FIGS. 1A, 1B, and 1C. As shown in FIG. 1B, a master disk 101 for magnetic transfer has a pattern 105 of magnetic material with a configuration of protrusions and recesses. As shown in FIGS. 1A and 1B, a ferromagnetic pattern 105 of the master disk 101 for magnetic transfer is brought into close constant with the medium 102 to receive transferred data, and an external magnetic field 106 is applied by magnets 103 in the direction parallel to the recording surface of the medium 102.

In the process as shown in FIG. 1B, a leakage magnetic flux 107 penetrates into the medium 102 at an edge of the ferromagnetic material of the ferromagnetic pattern 105. The leakage magnetic flux 107 magnetizes the magnetic layer 108 of the medium 102 in the perpendicular direction to record magnetic signals (servo data) 109 in the magnetic layer 108 in the perpendicular direction along the ferromagnetic pattern 105. As shown in FIG. 1A, two magnets 103 are disposed above and under the master disk 101 for magnetic transfer and the medium 102 to receive the transferred data, and rotate simultaneously to transfer the magnetic signals (servo data) 109 altogether onto the whole medium 102.

Another method of magnetic transfer to be applied to perpendicular magnetic recording media is a bit transfer method as shown in FIGS. 2A through 2E. First as shown in FIG. 2A, a first magnetic field is applied solely to the medium 102 to receive transferred data approximately in the perpendicular direction using magnets 103A. As a result as shown in FIG. 2B, the magnetic layer 108 of the medium 102 is magnetized in one direction, recording magnetic signals 109 in the same direction. Then as shown in FIG. 2C, the master disk 101 for magnetic transfer and the medium 102 are arranged in close contact with each other, and a second magnetic field is applied using magnets 103B in the direction approximately perpendicular to the medium and opposite to the first direction. As shown in FIG. 2D, the magnetic flux 110 of the second magnetic field concentrates at the parts of the ferromagnetic material of the pattern 105 and decreases at the parts outside of the ferromagnetic material of the pattern 105. As a result as shown in FIG. 2E, the recording signal (magnetization) 109 in the magnetic layer 108 is inverted into the direction of the second magnetic field at the parts of the ferromagnetic material in the pattern 105. At the parts where the magnetic materials in the pattern 105 are absent, the recording signals (magnetization) 109 in the magnetic layer 108 remain in the direction of the first magnetic field. Thus, a pattern of magnetization is transferred to the magnetic layer 108 of the medium 102 to receive transferred data corresponding to the pattern 105 of ferromagnetic material on the master disk for magnetic transfer 101.

Japanese Unexamined Patent Application Publication No. 2001-256644 discloses a method of manufacturing a master disk for use in the magnetic transfer. The method of Japanese Unexamined Patent Application Publication No. 2001-256644 uses electroforming technology. First in this method, a photoresist is applied onto a substrate. The substrate is subjected to electron beam irradiation while rotating, to draw a pattern on the photoresist corresponding to the transferring information. A development process follows to obtain an original master disk having a pattern of protrusions and recesses in the resist. Then, a nickel electroforming process is conducted on the pattern of protrusions and recesses of the master disk. Removing the master disk, a metal disk of nickel is obtained having the transferred pattern of protrusions and recesses. Finally, a soft magnetic film is formed on the metal disks with the pattern of protrusions and recesses, to obtain a master disk for magnetic transfer.

Japanese Unexamined Patent Application Publication No. 2001-034938 discloses a lift-off technology for manufacturing a master disk for magnetic transfer. In this technology, photoresist is first applied on a substrate. A drawing process is conducted on the photoresist by exposure to an electron beam and development to obtain a resist film having a pattern of opening parts. Then, a dry etching process is conducted on the substrate using the resist film as a mask to form recessed parts corresponding to the information to be transferred. Subsequently, a ferromagnetic thin film is deposited on the recessed parts of the substrate and the resist film by means of a sputtering method or the like. Subsequently, the resist film and the ferromagnetic thin film formed on the resist film are removed by the lift-off technique. Thus, a master disk for magnetic transfer is obtained that has a structure with the ferromagnetic thin film embedded at the recessed parts of the substrate.

However, in the method of manufacturing a master disk for magnetic transfer that uses the electroforming technique, as shown in FIG. 3, soft magnetic films 230 are also formed on the side surfaces of the pattern of protrusions and recesses on the metallic disk 220 having transferred pattern of protrusions and recesses of the original master disk. As a result, the width Wf of the protruding part of the soft magnetic layer 230 becomes wider than the width Wp of the protruding parts of the metallic disk 220. Thus, the manufacturing method using the electroforming technique has a problem that a pattern configuration, consequently a ratio of the width of the protruding parts to the width of the recessed parts, of the obtained master disk for magnetic transfer changes. In the case of forming a high definition pattern in particular, a problem emerges that the recessed parts are thoroughly filled with the soft magnetic film formed on the side faces of the protruding parts.

The method of manufacturing a master disk for magnetic transfer using the lift-off technique also has a risk that burrs may be formed at edges of the pattern of the ferromagnetic thin film after the lift-off step. If the burr is formed the burr inhibits close contact between the master disk and the medium to receive transferred data in the magnetic transfer step. In order to cope with this problem, a polishing process needs to be conducted for removing the burrs. The polishing process is an undesirable step in a manufacturing method of a master disk for magnetic transfer in which surface cleanliness is essential. Because polishing dust may be generated in the polishing step, surface cleanliness is degraded.

### SUMMARY OF THE INVENTION

It is therefore an object of the present invention to provide a method of manufacturing a master disk for magnetic transfer, in which a pattern configuration does not change and burrs that require a polishing process are not generated.

A method of manufacturing a master disk for magnetic transfer according to the invention comprises steps of; (a) preparing a nonmagnetic body; (b) forming a pattern of recessed parts on the nonmagnetic body; (c) forming a ferromagnetic material layer by depositing a ferromagnetic material on a surface of the nonmagnetic body having the pattern of recessed parts thereon; and (d) forming a pattern of ferromagnetic material layers at the recessed parts by removing an excessive (e.g., excess) portion of the ferromagnetic layer without using any mask at all. An etching rate of the ferromagnetic material layer is larger than an etching rate of the nonmagnetic body in step (d). In the method of the invention, step (d) can be carried out by a dry etching method without using a mask. A top surface of the ferromagnetic material layers formed in step (d) can be higher than a top surface of the nonmagnetic body by a dimension of a step larger than a surface roughness Rp of the nonmagnetic body. More specifically, a top surface of the ferromagnetic material layers formed in step (d) can be higher than a top surface of the nonmagnetic body by a dimension of a step not smaller than 4 nm.

In the method of the invention, the nonmagnetic body can comprise a substrate and a nonmagnetic layer formed on the substrate and the pattern of recessed parts can be formed on a surface of the nonmagnetic layer in step (b). In such a structure, an etching rate of the nonmagnetic layer can be larger than the etching rate of the ferromagnetic material layer in step (d).

Expressed in other terms, embodiments of the invention relate to a method that can comprise forming a pattern of recesses on a surface of a body for magnetically storing information to be transferred, and depositing a layer of magnetic material on the pattern. The method can further comprise removing at least a portion of the magnetic material from the surface of the body, while leaving at least a portion of the magnetic material in the recesses extending beyond a peak height of a feature in a surface roughness of the surface of the body. The method can still further comprise selecting the body so that the surface of the body has a higher etching rate than an etching rate of the magnetic material. The operation of removing at least a portion of the magnetic material from the surface of the body can include etching the layer of magnetic material, at least partly without using a mask.

Embodiments of the invention further relate to a device for magnetically storing and transferring information. The device can comprise a body having a pattern of recesses formed in a surface thereof, the pattern for storing information magnetically and transferring the information by contact with a receiving medium. The device can further comprise a magnetic material in the recesses extending beyond a peak height of a feature in a surface roughness of the surface of the body. The peak height can be smaller than a height of a step between a surface of the magnetic material in the recesses and the surface of the body.

A method of the present invention has advantages including: (i) the method does not cause change of a pattern, which is a problem in the case of using the electroforming technique; and (ii) the method does not generate burrs, the generation of burrs being a problem in the case of using a lift-off technique, and thus eliminating a need for a polishing step. Therefore, the method efficiently manufactures a master disk for magnetic transfer that transfers magnetic information with a high recording density.

### BRIEF DESCRIPTION OF THE DRAWINGS

FIGS. 1A, 1B and 1C are perspective views illustrating a magnetic transfer method using an edge transfer method of a conventional technology, each of FIGS. 1A, 1B, and 1C showing at least one step in the edge transfer method;

FIGS. 2A through 2E are perspective views illustrating a magnetic transfer method using a bit transfer method of a conventional technology, each of FIGS. 2A through 2E showing at least one step in the bit transfer method;

FIG. 3 is a sectional view of a master disk for magnetic transfer manufactured by a method using an electroforming technique of a conventional technology;

FIGS. 4A through 4D are sectional views illustrating a method of manufacturing a master disk for magnetic transfer according to the present invention, each of FIGS. 4A through 4D showing at least one step in the method of the invention;

FIGS. 5A through 5D are sectional views showing master disks for magnetic transfer, in which FIG. 5A shows a state formed with an ideal etching, FIG. 5B shows a state formed with an under-etching, FIG. 5C shows a state resulting from an over-etching where the etching rate of the ferromagnetic material layer is larger than the etching rate of the nonmagnetic body; and FIG. 5D shows a state resulting from an over-etching where the etching rate of the nonmagnetic body is larger than the etching rate of the ferromagnetic material layer;

FIG. 6 is a graph illustrating the surface roughness Rp of a nonmagnetic body in a method of manufacturing a master disk for magnetic transfer of the invention; and

FIGS. 7A and 7B are sectional views illustrating a magnetic transfer process in a method of manufacturing a master disk for magnetic transfer of the invention, in which FIG. 7A shows a case where the height of the step of the ferromagnetic material layer from the nonmagnetic body is larger than the surface roughness Rp of the nonmagnetic body, and FIG. 7B shows a case where the height of the step of the ferromagnetic material layer from the nonmagnetic body is smaller than the surface roughness Rp of the nonmagnetic body.

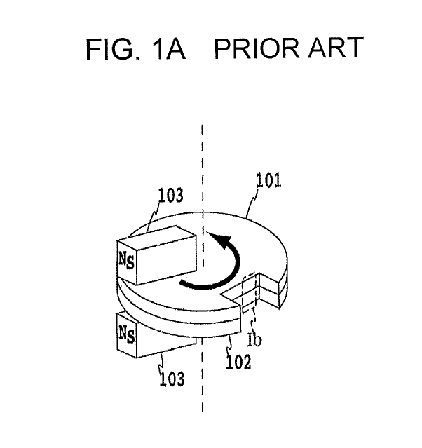

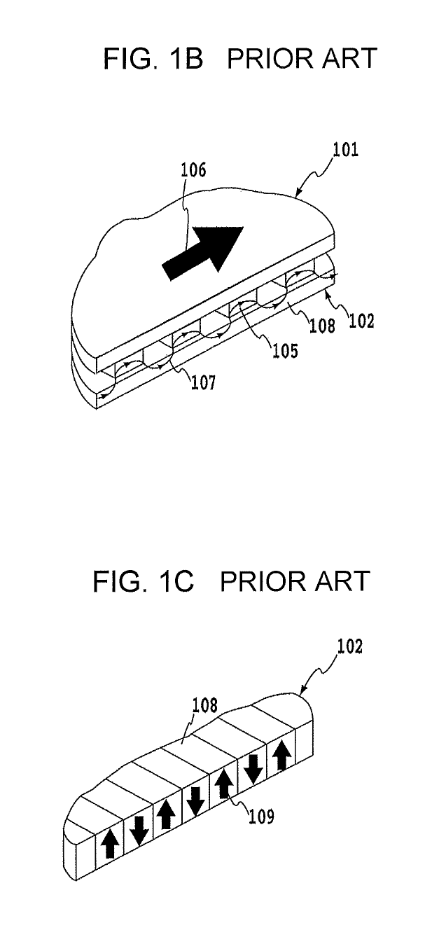

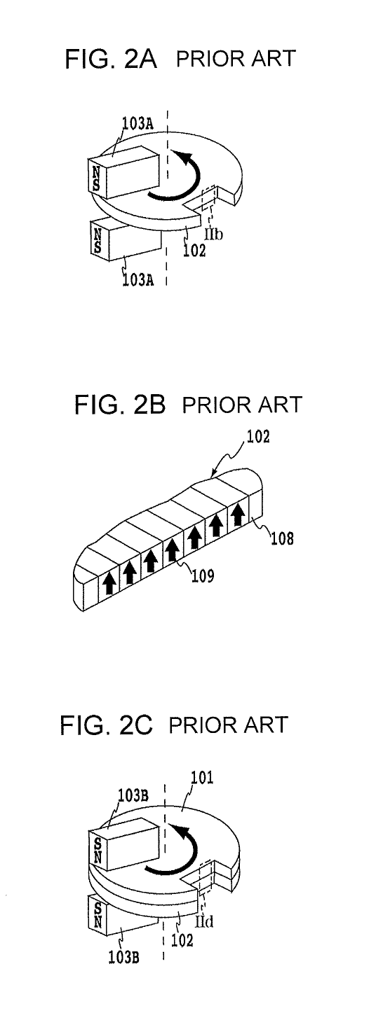

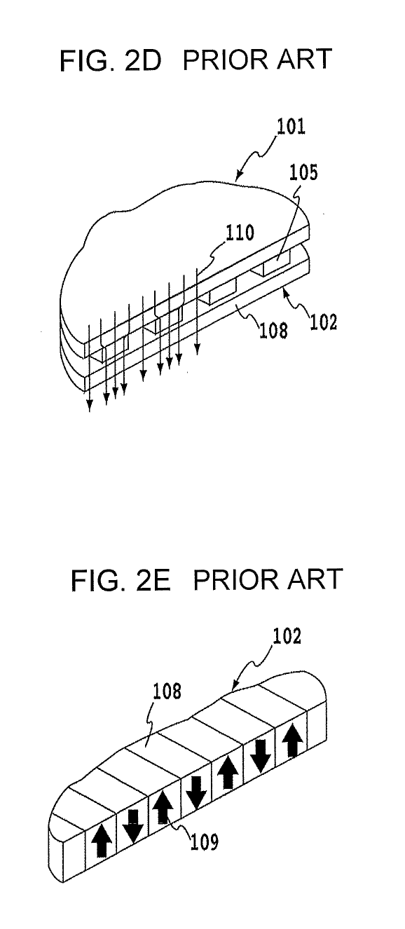

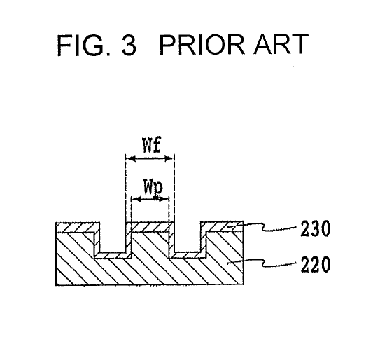

### DETAILED DESCRIPTION OF THE INVENTION

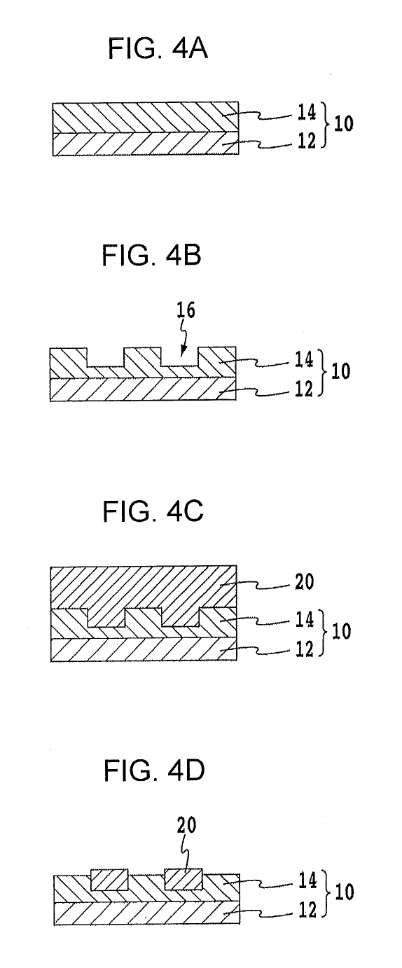

In the following, a method of manufacturing a master disk for magnetic transfer will be described with reference to FIGS. 4A through 4D which show an illustrative embodiment of the method of the invention. First, a nonmagnetic body 10 is prepared as shown in FIG. 4A. The nonmagnetic body 10 can be composed of a single material, or can have a laminated structure of a substrate 12 and a nonmagnetic layer 14 as shown in FIG. 4A. From a viewpoint of function separation by individual layers, the nonmagnetic body 10 can have a laminated structure comprising a substrate 12 and a nonmagnetic layer 14. In this laminated structure, the substrate 12 provides mechanical characteristics including rigidity and dimensional stability, and the nonmagnetic layer 14 provides etching characteristics in an etching process on a ferromagnetic material layer 20 described in the following.

The substrate 12 can be formed of any material that has sufficient rigidity and high dimensional stability. The substrate 12 can be nonmagnetic. Useful materials for the substrate 12 include glass, aluminum, silicon, and polycarbonate.

The nonmagnetic layer 14 can be formed using a nonmagnetic material such as SOG or carbon. A material used for forming the nonmagnetic layer 14 is decided depending on a material used for forming a ferromagnetic material layer 20, which will be described later, and on etching conditions for the ferromagnetic material layer 20. When the nonmagnetic body 10 is formed of a single material, a pattern is formed on the substrate.

In the case of using a nonmagnetic body 10 having a laminated structure of a substrate 12 and a nonmagnetic layer 14 as shown in FIG. 4A, the nonmagnetic layer 14 is formed by depositing the nonmagnetic material on the substrate 12 by means, for example, of an evaporation method, a sputtering method, a plating method, or an application method. A top surface of the nonmagnetic layer 14 is desired to be smooth.

Then, as shown in FIG. 4B, a pattern of recessed parts 16 is formed on the top surface of the nonmagnetic body 10. FIG. 4B shows an example of a laminated structure of a substrate 12 and a nonmagnetic layer 14 with the recessed parts 16. The recessed parts 16 may or may not pass through the nonmagnetic layer 14, but in FIG. 4B are illustrated as not passing through the nonmagnetic layer 14. Moreover, the recessed parts 16 can be formed so as to not pass through the entire nonmagnetic body 10. The recessed parts 16 can be formed by any method including the examples described below.

The first method for forming the recessed parts 16 is a photolithography method using a photosensitive resist material. First, a photosensitive resist material is applied on the surface of the nonmagnetic body 10 (or the nonmagnetic layer 14 in the case of a laminated structure), to form a resist film. Photosensitive resist materials useful in the present method include commonly used photosensitive resin materials. Then, the resist film is patterned according to preformatted signals, that is, information to be transferred. Patterning of the resist film can be carried out by commonly employed electron beam exposure and the following development process, for example. The nonmagnetic body 10 (or the nonmagnetic layer 14) is etched by a dry etching process using the obtained resist film with a pattern as a mask, to form the recessed parts 16. Corresponding to the sort of nonmagnetic body 10 (or nonmagnetic layer 14) used, a dry etching method is selected from methods such as a reactive ion etching (RIE) method, an ion beam etching method, and the like. A type of plasma generating gas and a type of ions to be used in the dry etching method are also chosen depending on the kind of the nonmagnetic body 10 (or the nonmagnetic layer 14).

The second method for forming the recessed parts 16 is a direct nano-imprinting lithography method on the nonmagnetic body 10. This method is effective in particular on a nonmagnetic body 10 (or the nonmagnetic layer 14 in the case of a laminated structure) that is susceptible to plastic deformation. In this method, an original master disk having a pattern of protrusions and recesses according to the preformat signals (information to be transferred) is pushed onto the nonmagnetic body 10 (or the nonmagnetic layer 14 in the case of a laminated structure) to deform the nonmagnetic body 10 (or the nonmagnetic layer 14), and then, the original master disk is removed. Thus, the recessed parts 16 are formed at the positions corresponding to protruding parts of the original master disk.

The third method for forming the recessed parts 16 is a nano-imprinting lithography method in which a resist is used. This method is effective in the case where the nonmagnetic body 10 (or the nonmagnetic layer 14 in the case of a laminated structure) is rather difficult to plastically deform, and thus, the nano-imprinting lithography method cannot be directly applied to the nonmagnetic body 10 (or the nonmagnetic layer 14). First, a resist material is applied on the surface of the nonmagnetic body 10 (or the nonmagnetic layer 14 in the case of a laminated structure) to form a resist film. In this method in particular, useful materials include thermoplastic resins such as polymethyl methacrylate (PMMA) and SOG as well as the commonly used photosensitive resin materials. Then, an original master disk having a pattern of protrusions and recesses according to preformat signals (information to be transferred) is pushed onto the resist film to transfer a reversed pattern of protrusions and recesses onto the resist film. Here, a portion of the resist material is allowed to remain on the bottom face of the recessed part formed in the resist film. If some resist material remains on the bottom face of the recessed part, the remaining resist material is eliminated to expose the surface of the nonmagnetic body 10. This process of eliminating the remaining resist material can also be executed on the protruding parts of the resist film in the condition in which a sufficient thickness of the resist material is eventually left for using the resist as a mask in the following process of patterning the nonmagnetic body 10. Elimination of the remaining resist material in the case of SOG can be carried out by means of a dry etching method such as a reactive ion etching (RIE) method using CF4 gas, for example. When the resist material is a resin material such as a photosensitive resin material or a thermoplastic resin material, elimination of the resist material can be carried out by means of a dry etching method such as a reactive ion etching (RIE) method using oxygen gas.

Then, the nonmagnetic body 10 (or the nonmagnetic layer 14 in the case of a laminated structure) is patterned with the resist film having a pattern of protrusions and recesses as a mask, depending on the material used for the nonmagnetic body 10 (or the nonmagnetic layer 14). In the case of the nonmagnetic body of carbon or resin material, the patterning process can be carried out by means of a dry etching method such as a reactive ion etching (RIE) process using oxygen gas. In the case of the nonmagnetic body of silicon, the patterning process can be executed by means of a dry etching method such as a reactive ion etching (RIE) process using CF4 gas or SF6 gas.

Finally, the resist film used for the mask is removed. Removal of the resist film can be carried out in the case of a resin material of SOG, by means of a reactive ion etching (RIE) process using CF4 gas as described above. In the case of the resist material of a resin material, the resist film can be removed by means of a dry etching method such as a reactive ion etching process using oxygen gas.

Subsequently as shown in FIG. 4C, a ferromagnetic material is deposited on the surface of the nonmagnetic body 10 with recessed parts 16 formed thereon to form a ferromagnetic material layer 20. Ferromagnetic materials useful in a method of the invention include iron, an iron-cobalt alloy, and a nickel iron alloy. A ferromagnetic material used in a method of the invention can have a permeability more than 100 times larger than that of the nonmagnetic body 10. The ferromagnetic material can be deposited by means of, for example, a sputtering method, an evaporation method, or a plating method, and the like. The top surface of the ferromagnetic material layer 20 may need to be made generally flat in this step, because a flatness of the top surface of the ferromagnetic material layer 20 at the end of this step will affect this process.

When the ferromagnetic material is deposited by a plating method, a thickness of the ferromagnetic material layer 20 may need to be larger than two times the width of the recessed part of the nonmagnetic body 10. This is for the purpose of fast filling of the recessed parts with the ferromagnetic material, which is deposited from both the bottom and side faces of the recessed part in the plating method. The “thickness of the ferromagnetic material layer 20” in the present invention means a thickness of the layer on the protruding part of the nonmagnetic body 10 (or the nonmagnetic layer 14). In the case of employing a sputtering method, a thickness of the ferromagnetic material layer 20 may need to be larger than four times the width of the recessed part of the nonmagnetic body 10. This is because it is difficult in the sputtering method to equalize deposition rates of the ferromagnetic material at the bottom face of the recessed part, the top face of the protruding part, and the side face of the recessed part. In the case of employing an evaporation method, a thickness of the ferromagnetic material layer 20 may need to be larger than six times the width of the recessed part of the nonmagnetic body 10. This is because a deposition rate at the side face of the recessed part is further decreased in the evaporation method as compared with the sputtering method.

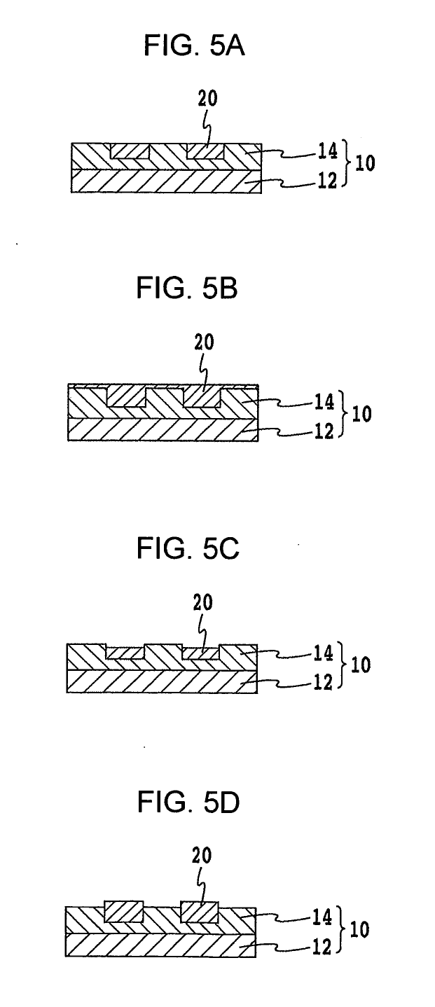

Finally, as shown in FIG. 4D, an excessive (e.g., excess) portion of the ferromagnetic material layer 20 is removed without using any mask at all, to form a pattern of the ferromagnetic material layer 20 at the recessed parts 16. This step can be carried out by etching the ferromagnetic material layer 20 by means of a dry etching method without using any mask. FIGS. 5A through 5D are examples of sectional views after completion of this etching process. Ideally, as shown in FIG. 5A, the etching of the magnetic material layer 20 is stopped at the top surface of the nonmagnetic body 10 (or the nonmagnetic layer 14 in the case of a laminated structure) so that the top surface of the nonmagnetic body 10 (or the nonmagnetic layer 14) matches (e.g., aligns) with the top surface of the ferromagnetic material layer 20. In actual practice, however, it is difficult to attain the state of FIG. 5A due to factors including inaccuracy in thickness of the ferromagnetic material layer 20 and inaccuracy in an etching rate for the ferromagnetic material layer 20. Thus, a state of over-etching or under-etching is common in most cases. Under-etching produces, as shown in FIG. 5B, a master disk for magnetic transfer having a thin ferromagnetic material layer 20 remaining on the protruding parts, in addition to the ferromagnetic material in the recessed parts of the nonmagnetic body 10 (or the nonmagnetic layer 14). If a magnetic transfer process is executed using a master disk for magnetic transfer as shown in FIG. 5B, efficient application of a magnetic field cannot be performed due to the ferromagnetic material layer 20 remaining on the surface of the protruding parts of the nonmagnetic body 10 (or the nonmagnetic layer 14). Further, since it is difficult to grasp a thickness of the ferromagnetic material layer remaining on the surface of the protruding parts in a nondestructive way, it is difficult to establish a stable procedure for manufacturing a master disk. Accordingly, etching conditions are set that would result in slightly over-etching in the actual etching process of the ferromagnetic material layer 20 and the nonmagnetic body 10 (or the nonmagnetic layer 14) in this step.

In the case of over-etching and where an etching rate for the ferromagnetic material of the ferromagnetic material layer 20 is larger than an etching rate for the nonmagnetic material of the nonmagnetic body 10 (or the nonmagnetic layer 14 in the case of a laminated structure), as shown in FIG. 5C a master disk for magnetic transfer is obtained in which the top surface of the magnetic material layer 20 remaining in the recessed part is lower than the top surface of the nonmagnetic body (or the nonmagnetic layer 14). This situation generates a so-called “spacing loss”, inhibiting efficient application of a magnetic field.

In order to cope with this problem, in the method of the invention, a ferromagnetic material, a nonmagnetic material, and an etching method are selected so that an etching rate of the nonmagnetic material of the nonmagnetic body 10 (or the nonmagnetic layer 14 in the case of a laminated structure) is larger than an etching rate of the ferromagnetic material of the ferromagnetic material layer 20. This provides a master disk for magnetic transfer in which the top surface of the ferromagnetic material layer 20 remaining at the recessed parts of the nonmagnetic body 10 (or the nonmagnetic layer 14) is at a higher level than the top surface of the nonmagnetic body 10 (or the nonmagnetic layer 14) as shown in FIG. 5D.

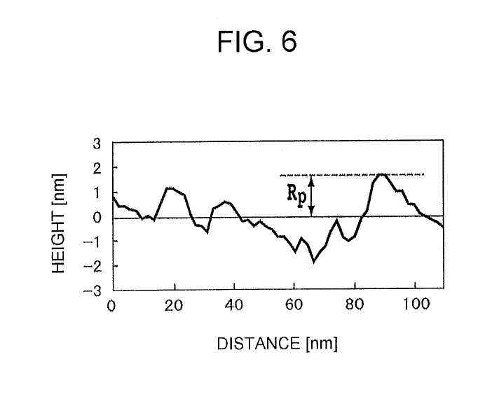

One of the matters that should be taken into consideration in a master disk for magnetic transfer having a sectional configuration as shown in FIG. 5D is surface roughness of the nonmagnetic body 10 (or the nonmagnetic layer 14 in a case of laminated structure). A surface roughness of the nonmagnetic body 10 (or the nonmagnetic layer 14) is evaluated in the present invention by a peak height Rp. The peak height Rp is measured from a roughness curve along a specified basic length as a height of the peak projecting out furthest from the line of average of the roughness curve as shown in FIG. 6. In the present invention, Rp values are measured at 9 places each having a basic length of 1,000 nm chosen at random on the surface of the nonmagnetic body 10 (or the nonmagnetic layer 14) of a master disk for magnetic transfer.

An Rp value for the overall nonmagnetic body 10 (or the nonmagnetic layer 14) is defined by Av+3σ, where Av is an average value of the Rp over the 9 places and a is a standard deviation of the measured Rp values.

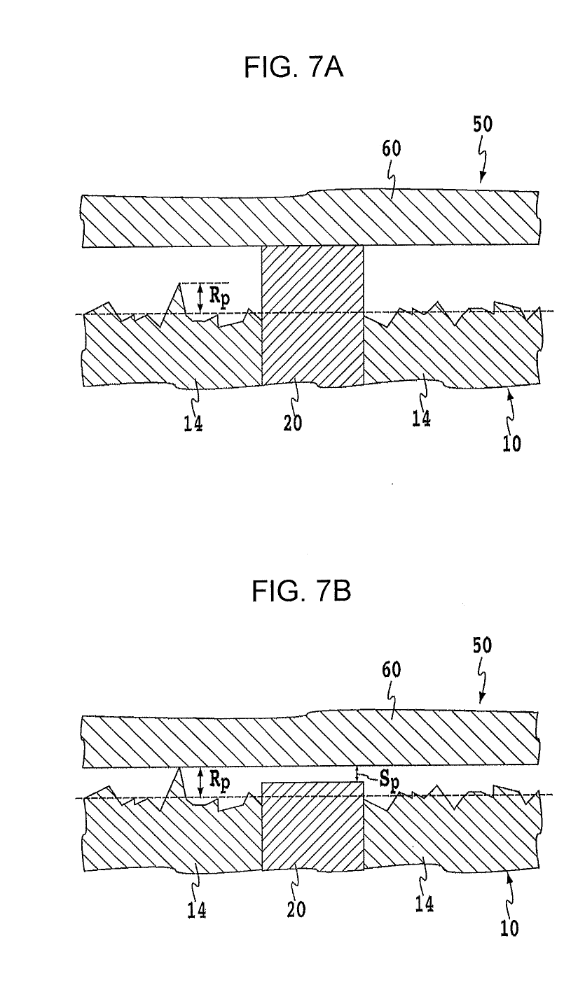

When the Rp of the nonmagnetic body 10 (or the nonmagnetic layer 14 in a case of a laminated structure) is smaller than the height of the step between the top surface of the ferromagnetic material layer 20 and the top surface of the nonmagnetic body 10 (or the nonmagnetic layer 14) as shown in FIG. 7A, the medium to receive transferred data 50, more specifically the magnetic layer 60, can be brought into close contact with the ferromagnetic material layer 20, thereby performing good magnetic transfer. When the Rp of the nonmagnetic body 10 (or the nonmagnetic layer 14) is larger than the height of the step between the top surface of the ferromagnetic material layer 20 and the top surface of the nonmagnetic body 10 (or the nonmagnetic layer 14) as shown in FIG. 7B, the medium to receive transferred data 50 cannot be brought into close contact with the ferromagnetic material layer 20 due to the Rp of the nonmagnetic body 10 (or the nonmagnetic layer 14), leaving a separation gap Sp. The gap Sp generates the spacing loss as described previously referring to FIG. 5(c), inhibiting efficient magnetic transfer. Accordingly, in the present invention, the Rp value of the nonmagnetic body 10 (or the nonmagnetic layer 14) can be smaller than the height of the step between the top surface of the ferromagnetic material layer 20 and the top surface of the nonmagnetic body 10 (or the nonmagnetic layer 14). In ordinary dry etching conditions, such a relationship between the Rp value and the height of the step is fulfilled by setting the height of the step between the top surface of the ferromagnetic material layer 20 and the top surface of the nonmagnetic body 10 (or the nonmagnetic layer 14) at a value at least 4 nm.

An ion beam etching method is a dry etching method useful in this step. Useful gases for the ion beam etching process include inert gases such as argon.

Combinations of <nonmagnetic material, ferromagnetic material, dry etching method> include:

<SOG, FeCo, ion beam etching method using argon gas>;

<carbon, FeCo, ion beam etching method using argon gas>;

<silicon, FeCo, ion beam etching method using argon gas>;

The method of the invention as described above has advantages of (i) the method does not cause change of a pattern configuration, which is a problem in the case of using the electroforming technique; and (ii) the method does not generate burrs, the generation of burrs being a problem in the case of using a lift-off technique. Thus, the method can eliminate a need for a polishing step. Therefore, the method efficiently manufactures a master disk for magnetic transfer that transfers magnetic information with a high recording density.

### EXAMPLES

### Example 1

This example includes nonmagnetic body 10 with a laminated structure comprising a substrate 12 and a nonmagnetic layer 14 and carried out by means of a direct nano-imprinting lithography method for forming protrusions and recesses on the nonmagnetic layer 14.

First, SOG (spin-on glass) was applied on a substrate 12 of a silicon substrate by means of a spin coating method to form a nonmagnetic layer 14 with a thickness of 70 nm.

Subsequently, a nickel stamper having a pattern of protrusions and recesses formed according to the information to be transferred was pushed for imprinting on the surface of the nonmagnetic layer 14, and the nickel stamper was removed to form a pattern of protrusions and recesses on the surface of the nonmagnetic layer 14. The recessed parts 16 formed on the nonmagnetic layer 14 had a depth of 50 nm and a width (a pattern width) of 70 nm. After forming the pattern of protrusions and recesses, the nonmagnetic body composed of the substrate 12 and the nonmagnetic layer 14 was heated at 200° C. for 60 min to solidify the SOG forming the nonmagnetic layer 14.

Subsequently, FeCo with cobalt content of 30 at % was deposited on the surface of the nonmagnetic layer 14 by means of a sputtering method to form a ferromagnetic material layer 20 having a thickness of 300 nm.

Subsequently, the ferromagnetic material layer 20 was etched by means of an ion beam etching method using argon ions. In the conditions of Example 1, an etching rate of the SOG comprising the nonmagnetic layer 14 was 1.5 nm/s (nanometers per second) and an etching rate of the FeCo composing the ferromagnetic material layer 20 was 0.5 nm/s. Time duration for the etching process was 610 s in total, which is 600 s for removing the ferromagnetic material layer 20 formed on the nonmagnetic layer 14 plus 10 s for over-etching. An eventually-obtained master disk for magnetic transfer comprised a substrate 12, a nonmagnetic layer 14 with a thickness of 35 nm, and a ferromagnetic material layer 20 with a thickness of 45 nm formed in the recessed parts 16 in the nonmagnetic layer 14. A height of the step between the top surface of the nonmagnetic body 10 (or the nonmagnetic layer 14) and the top surface of the ferromagnetic material layer 20 was 10 nm.

### Example 2

This example includes a nonmagnetic body 10 having a laminated structure composed of a substrate 12 and a nonmagnetic layer 14, and a configuration of protrusions and recesses on the nonmagnetic layer 14 was formed by means of an indirect nano-imprinting method using a resist.

First, carbon was deposited on a substrate 12 of silicon substrate by a sputtering method to form a nonmagnetic layer 14 with a thickness of 70 nm.

Then, SOG was applied on the top surface of the nonmagnetic layer 14 by a spin-coating method to form a resist layer 70 nm thick.

Subsequently, a nickel stamper having a pattern of protrusions and recesses formed according to the information to be transferred was pushed for imprinting onto the surface of the resist layer, and the stamper was removed to form a pattern of protrusions and recesses on the surface of the resist layer. Then, the SOG remained on the bottom face of the recessed parts of the resist layer was removed by means of a reactive ion etching (RIE) method using CF4 gas, to obtain a resist layer having a pattern with multiple of through-holes.

Subsequently, using the patterned resist layer as a mask, the nonmagnetic layer 14 of carbon was etched by means of a reactive ion etching (RIE) method using oxygen gas. An etching depth of the nonmagnetic layer 14 was 70 nm, which was sufficient to pass through the nonmagnetic layer 14. Then, the reactive ion etching (RIE) process was again conducted using CF4 gas to remove the patterned resist layer of SOG used for a mask.

Through the above-described procedure, a nonmagnetic body 10 was obtained that had a laminated structure composed of the substrate 12 and the nonmagnetic layer 14, and includes recessed parts 16 passing through the nonmagnetic layer 14. The recessed parts 16 of the nonmagnetic body 10 had a depth of 70 nm and a width, a pattern width, of 70 nm.

Subsequently, FeCo with a cobalt content of 30 at % was deposited on the surface of the nonmagnetic layer 14 by a sputtering method to form a ferromagnetic material layer 20 with a thickness of 300 nm.

Subsequently, the ferromagnetic material layer 20 was etched by means of an ion beam etching method using argon ions. In the conditions of Example 2, an etching rate of the carbon composing the nonmagnetic layer 14 was 0.6 nm/s and an etching rate of the FeCo composing the ferromagnetic material layer 20 was 0.5 nm/s. Time duration for the etching process was 660 s in total, which was 600 s for removing the ferromagnetic material layer 20 formed on the nonmagnetic layer 14 plus 60 s for 10% over-etching. An eventually-obtained master disk for magnetic transfer comprised a nonmagnetic layer 14 with a thickness of 34 nm and a ferromagnetic material layer 20 with a thickness of 40 nm formed in the recessed parts 16 in the nonmagnetic layer 14. A height of the step between the top surface of the nonmagnetic body 10 (or the nonmagnetic layer 14) and the top surface of the ferromagnetic material layer 20 was 6 nm.

On the obtained master disk for magnetic transfer of Example 2, nine places were chosen at random on the exposed top surface of the nonmagnetic body 10 (or the nonmagnetic layer 14), roughness curves were measured along a basic length of 1,000 nm to obtain the peak heights Rp, the result of which are given in Table 1.

TABLE 1

| place | Rp (nm) |
|---|---|
| 1 | 1.7 |
| 2 | 0.7 |
| 3 | 1.4 |
| 4 | 1.9 |
| 5 | 0.8 |
| 6 | 1.9 |
| 7 | 3.1 |
| 8 | 1.5 |
| 9 | 1.0 |
| average Av(nm) | 1.6 |
| standard deviation σ (nm) | 0.7 |

From the result, the peak height Rp of the overall nonmagnetic body 10 (or the nonmagnetic layer 14) was calculated to be 3.7 nm, which is a value of Av+3σ. Consequently, it can be seen that when the top surface of the ferromagnetic material layer 20 is made higher than the top surface of the nonmagnetic body 10 (or the nonmagnetic layer 14) by 4 nm or more, the ferromagnetic material layer 20 can be brought into close contact with the medium 50 (magnetic layer 60) to receive transferred data in a step of magnetic transfer, without an adverse influence. In the master disk for magnetic transfer of this Example 2, the height of the step between the top surface of the ferromagnetic material layer 20 and the top surface of the nonmagnetic body 10 (or the nonmagnetic layer 14) was 6 nm. Consequently, a good magnetic transfer performance was attained using the master disk for magnetic transfer of this Example 2, because a magnetic field was efficiently applied on the medium 50 (magnetic layer 60) to receive transferred data in the magnetic transfer step.

### Comparative Example

This example includes a nonmagnetic body 10 having a laminated structure composed of a substrate 12 and a nonmagnetic layer 14, and a configuration of protrusions and recesses on the nonmagnetic layer 14 was formed by means of an indirect nano-imprinting lithography method using a resist.

First, carbon was deposited on a substrate 12 of silicon substrate by a sputtering method to form a nonmagnetic layer 14 with a thickness of 70 nm.

Then, SOG was applied on the top surface of the nonmagnetic layer 14 by a spin-coating method to form a resist layer 70 nm thick.

Subsequently, a nickel stamper having a pattern of protrusions and recesses formed according to the information to be transferred was pushed for imprinting onto the surface of the resist layer, and the stamper was removed to form a pattern of protrusions and recesses on the surface of the resist layer. Then, the SOG remaining on the bottom face of the recessed parts of the resist layer was removed by means of a reactive ion etching (RIE) method using CF4 gas, to obtain a resist layer having a pattern with multiple of through-holes.

Subsequently, using the patterned resist layer as a mask, the nonmagnetic layer 14 of carbon was etched by means of a reactive ion etching (RIE) method using oxygen gas. An etching depth of the nonmagnetic layer 14 was 70 nm, which was sufficient to pass through the nonmagnetic layer 14. Then, the reactive ion etching (RIE) process was again conducted using CF4 gas to remove the patterned resist layer of SOG used for a mask.

Through the above-described procedure, a nonmagnetic body 10 was obtained that has a laminated structure composed of the substrate 12 and the nonmagnetic layer 14, and includes recessed parts 16 passing through the nonmagnetic layer 14. The recessed parts 16 of the nonmagnetic body 10 had a depth of 70 nm and a width, a pattern width, of 70 nm.

Subsequently, FeCo with a cobalt content of 30 at % was deposited on the surface of the nonmagnetic layer 14 by a sputtering method to form a ferromagnetic material layer 20 with a thickness of 300 nm.

Subsequently, the excess ferromagnetic material layer 20 was removed by CMP (chemical mechanical polishing). Since a polishing rate was about 20 nm/min, a process time was set to be 16.5 min, which was 15 min for removing the ferromagnetic material layer 20 on the nonmagnetic layer 14 plus 1.5 min for 10% over-etching.

The master disk manufactured in the above-described procedure had a configuration in which the top surface of the ferromagnetic material layer 20 is lower than the top surface of the nonmagnetic body 10 (or the nonmagnetic layer 14) by 6 nm.

Using the master disk manufactured in this Comparative Example and the master disk manufactured in Example 2, a process of magnetic transfer was actually executed onto a magnetic recording medium, and amplitudes of transferred signals were compared. A transferring method used was an edge transfer method.

Let the amplitude of the transferred signal using the master disk of Example 2 be 1, the amplitude of the transferred signal using the master disk of Comparative Example was 0.82.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A method of manufacturing a master disk for magnetic transfer comprising steps of:
(a) preparing a nonmagnetic body;
(b) forming a pattern of recessed parts on the nonmagnetic body;
(c) forming a ferromagnetic material layer by depositing a ferromagnetic material on a surface of the nonmagnetic body having the pattern of recessed parts thereon; and
(d) forming a pattern of ferromagnetic material layers at the recessed parts by removing an excess portion of the ferromagnetic layer without using any mask at all;
wherein an etching rate of the nonmagnetic body is larger than an etching rate of the ferromagnetic material layer in step (d).

2. The method of manufacturing a master disk for magnetic transfer according to claim 1, wherein step (d) is carried out by a dry etching method without using a mask.

3. The method of manufacturing a master disk for magnetic transfer according to claim 1, wherein a top surface of the ferromagnetic material layers formed in step (d) is higher than a top surface of the nonmagnetic body by a dimension of a step larger than a surface roughness Rp of the nonmagnetic body.

4. The method of manufacturing a master disk for magnetic transfer according to claim 1, wherein a top surface of the ferromagnetic material layers formed in step (d) is higher than a top surface of the nonmagnetic body by a dimension of a step not smaller than 4 nm.

5. The method of manufacturing a master disk for magnetic transfer according to claim 1, wherein
the nonmagnetic body comprises a substrate and a nonmagnetic layer formed on the substrate;
the pattern of recessed parts is formed on a surface of the nonmagnetic layer in step (b); and
an etching rate of the nonmagnetic layer is larger than the etching rate of the ferromagnetic material layer in step (d).

6. A method comprising:
forming a pattern of recesses on a surface of a body for magnetically storing information to be transferred;
depositing a layer of magnetic material on the pattern;
removing at least a portion of the magnetic material from the surface of the body, while leaving at least a portion of the magnetic material in the recesses extending beyond a peak height of a feature in a surface roughness of the surface of the body.

7. The method of claim 6, further comprising selecting the body so that the surface of the body has a higher etching rate than an etching rate of the magnetic material.

8. The method of claim 7, the removing including etching the layer of magnetic material.

9. The method of claim 8, comprising etching the layer of magnetic material at least partly without using a mask.

10. The method of claim 6, further comprising laminating a non-magnetic layer on a substrate to form the body.

11. A device for magnetically storing and transferring information, comprising:
a body having a pattern of recesses formed in a surface thereof, the pattern for storing information magnetically and transferring the information by contact with a receiving medium; and
a magnetic material in the recesses extending beyond a peak height of a feature in a surface roughness of the surface of the body.

12. The device of claim 11, wherein the peak height is smaller than a height of a step between a surface of the magnetic material in the recesses and the surface of the body.

13. The device of claim 11, further comprising a receiving medium in contact with the magnetic material in at least one of the recesses.

14. The device of claim 12, wherein the height of the step is at least 4 nm.

15. The device of claim 11, the body comprising a non-magnetic layer formed on a substrate.
